(19) United States
(12) Patent Application Publication
(10) Pub. No.: US 2024/0416846 A1
(43) Pub. Date: Dec. 19, 2024

(54) VEHICLE ROOF, COMPRISING A SENSOR MODULE HAVING AN ENVIRONMENT SENSOR ARRANGEMENT

(71) Applicant: Webasto SE, Stockdorf (DE)

(72) Inventors: Magnus SVIBERG, Stockdorf (DE); Maximilian EHRMANN, Stockdorf (DE); Cèdric LANGLAIS, Stockdorf (DE); Michael HUELSEN, Stockdorf (DE)

(21) Appl. No.: 18/743,341

(22) Filed: Jun. 14, 2024

(30) Foreign Application Priority Data
Jun. 15, 2023 (DE) 10 2023 115 626.8

(51) Int. Cl. B60R 11/00

(52) U.S. Cl. CPC B60R 11/00; B60R 2011/004; B60R 2011/0094

(57) ABSTRACT

A vehicle roof having a roof skin, a carrying element and at least one sensor module which is disposed on the carrying element and by means of which a vehicle environment is detectable for an autonomous and/or semi-autonomous driving mode of the respective vehicle, said sensor module having an environment sensor arrangement. The sensor module is provided with a displacement element by means of which it is displaceable between at least two detection directions.

### CROSS-REFERENCE TO RELATED APPLICATION(S)

This application claims the benefit of German patent application no. 10 2023 115 626.8 filed on Jun. 15, 2023, which is incorporated herein by reference in its entirety.

### TECHNICAL FIELD

This disclosure relates generally to a vehicle roof and to a motor vehicle having a vehicle roof of this kind.

### BACKGROUND

A vehicle roof of this kind is known from practice and is in particular a roof module, which is prefabricated as a separate function module and which can be placed on top of a vehicle body or a vehicle carcass by a vehicle manufacturer during the vehicle production. The vehicle roof comprises a roof skin which forms an outer viewing area of the vehicle roof and which can be made from a dimensionally stable material, for example sheet metal or a plastic material. The known vehicle roof also comprises a carrying element, which is formed in particular as a roof frame and on which a sensor module is disposed, which comprises at least one environment sensor, which can detect the vehicle environment using electromagnetic radiation. In this way, the environment sensor arrangement can be used to collect data which can be used by a vehicle control system for an autonomous and/or semi-autonomous driving mode of the vehicle in question. The environment sensor is in particular configured as a lidar sensor, as a radar sensor, as an optical sensor, like a camera. In accordance with the environment data, which is collected by means of the environment sensor and which corresponds with a respective traffic situation, the vehicle control system can affect the driving mode of the respective vehicle. Both the sensor module and the roof frame are covered by the roof skin. The environment sensor is rigidly disposed on the roof frame. This defines the direction of observation or the field of view of the environment sensor.

### SUMMARY

The object of the disclosure is to provide a vehicle roof of the kind described above in which the detection options, which the sensor module provides, are extended compared to the state of the art.

According to the invention, this object is attained by the vehicle roof having the features of claim 1.

According to the invention, a vehicle roof is proposed which comprises a roof skin, which in particular forms an outer viewing area of the vehicle roof, which comprises a carrying element and which comprises at least one sensor module having an environment sensor arrangement, said sensor module being disposed on the carrying element and a vehicle environment for an autonomous and/or semi-autonomous driving mode of the respective vehicle being able to be detected by means of said sensor module. The sensor module comprises a displacement element by means of which it is displaceable between at least two detection directions.

The sensor module of the vehicle roof according to the invention therefore has extended detection options due to the displacement element because an alignment in different detection directions can be realized. Depending on the requirements, the environment sensor arrangement or the sensor module can be brought into a position which corresponds with an intended field of view, which can be used by a control of the respective motor vehicle.

For example, the detection directions, which can be realized by means of the displacement element of the sensor module, are chosen such that one detection direction points to the direction of the front of the vehicle, one detection direction points to the direction of the side of the vehicle, one detection direction points upwards, one detection direction points to the direction of the back of the vehicle and/or one detection direction points to the vehicle interior. In particular, at least two of these detection directions can be realized by means of the displacement element of the vehicle roof according to the invention.

For example, a detection direction pointing to the vehicle environment can be selected to supply data to an autonomous driving mode, a speed control system and/or a lane departure warning system. Another detection direction pointing to the vehicle environment can be used for a parking functionality, a reverse driving functionality and/or when operating the vehicle in question with a trailer. Additionally, one of the detection directions can be used for measuring the environment, in particular parking spaces and/or for self-learning of the autonomous driving system. Furthermore, one of the detection directions can be used for navigation purposes, for detecting the weather and/or for other informational purposes for vehicle occupants. It is also possible, if the detection direction points to the vehicle interior, to determine an occupancy of the respective vehicle or to use the sensor module for drowsiness detection of a vehicle occupants and thus in connection with an alarm system.

Since all the aforementioned detection options can be realized by the same sensor module in the vehicle roof according to the invention, there is a reduced installation space requirement and the possibility of an appealing design of the vehicle roof compared to the state of the art regarding the sensor module, and at lower manufacturing costs.

The various detection directions can each be used over a long period of time, for example in the driving mode of the respective vehicle, or only for snapshots, for example to record a sky image that can be shown on a display in the vehicle interior.

In principle, the displacement element of the sensor module of the vehicle roof according to the invention can comprise different mechanisms and kinematics by means of which a change in the field of view of the environment sensor arrangement can be achieved.

In a specific embodiment of the vehicle roof according to the invention, the displacement element comprises a rotary plate. The environment sensor arrangement can be disposed on the rotary plate, so that by actuating said rotary plate, the environment sensor arrangement is displaced in another detection direction.

To be able to displace or to pivot the environment sensor arrangement in an additional spatial direction, the displacement element can comprise a bearing element, on which the environment sensor arrangement is mounted so as to be pivotable. The bearing element, which is formed from a fork-like bracket, for example, can be disposed on the rotary plate.

In another specific embodiment of the vehicle roof according to the invention, the sensor module comprises at least one beam deflecting element by means of which electromagnetic radiation, which is used by the environment sensor arrangement, can be deflected. The beam deflecting element comprises, for example, a pivotable mirror and/or a fixed mirror and/or an optical prism and is adjusted to the type of environment sensor used.

In another specific embodiment of the vehicle roof according to the invention, the beam deflecting element is disposed on the rotary plate. In this case, the environment sensor arrangement can be disposed so as to be rigid or immovable relative to the vehicle carcass, the rotary plate being able to be rotated to realize the different detection directions such that the respective beam deflecting element is brought in front of the environment sensor, said rotary plate being ring-like, in particular, and being provided with the beam deflecting element. For example, an optical prism is brought in front of the environment sensor arrangement, via which the electromagnetic radiation used by the environment sensor is deflected, whereby the environment sensor arrangement can monitor the interior of the respective vehicle. Additionally or alternatively, the beam deflecting element can comprise a mirror by means of which a surrounding area to the side of the respective vehicle or the sky above the respective vehicle can be detected and evaluated.

In another preferred embodiment of the vehicle roof according to the invention, the environment sensor arrangement of the sensor module comprises at least two different types of sensors which can be used either simultaneously or individually. In particular, the environment sensor arrangement realized in this manner comprises two sensors which can be configured as optical sensors, such as a camera, as lidar sensors, as radar sensors and/or the like. The environment and/or the interior of the respective motor vehicle can be detected by means of environment sensors realized in this manner. A control of the vehicle can evaluate and use the measured data collected from these sensors, in particular for the driving mode of the respective vehicle in an autonomous or semi-autonomous driving mode.

If the environment sensor arrangement comprises a plurality of sensors, they can be disposed in a shared housing or also in separate housings. In addition, it is conceivable that the individual sensors are displaceable together or independent of each other by means of the displacement element, in order to set the different detection directions.

Advantageously, the vehicle, which is equipped with the vehicle roof according to the invention, has sensor see-through portions, which allow the environment sensor arrangement to have a clear or defined view of the vehicle environment and/or the vehicle interior with an alignment in one of the detection directions. The sensor see-through portions, which are disposed on the roof skin or on a vehicle headliner, for example, or which are formed from a windshield or from a side window or from a rear window of the respective vehicle, are advantageously transparent for the wavelengths used by the environment sensor arrangement in the respective detection direction. In particular, the sensor see-through portions are transparent for wavelengths in a range between 200 nm to 2000 nm. A lidar sensor preferably operates within a wavelength range of approximately 905 nm or of approximately 1,550 nm. A camera used as an environment sensor can operate in the wavelength range of visible light and/or within the infrared range.

In another specific embodiment of the vehicle roof according to the invention, the sensor module comprises at least one sensor cover, which has cover openings or window-like cut-outs, which are each assigned to one detection direction. The sensor cover can be designed like a housing and at least partially enclose the environment sensor arrangement.

A specific embodiment of the vehicle roof according to the invention is configured as a roof module which forms a modular unit connectable to a vehicle body. In the form of the sensor module with the environment sensor arrangement, the modular unit therefore incorporates functionalities which are required for autonomously or semi-autonomously driving the respective vehicle. A vehicle manufacturer can connect the modular unit to a vehicle body or to a vehicle carcass, which can comprise roof rails, such as roof side rails and transverse roof rails, as an interface to the roof module. By integrating the sensor system provided by the sensor module, the vehicle roof configured as a roof module is a so-called roof sensor module (RSM), which allows the respective vehicle to be driven autonomously or semi-autonomously.

The vehicle, which is equipped with the vehicle roof according to the invention and which is an autonomously driving vehicle, drives independently in the autonomous driving mode, at least without significant intervention by a driver. For a semi-autonomous driving mode, the vehicle roof according to the invention can form a part of a driver assistance system.

In particular, the vehicle roof according to the invention is a roof of a passenger car. However, it can also be a roof of a commercial vehicle, which can be configured as a delivery van, as a bus, as an autonomously driving minibus, such as a so-called people mover, or even as a tractor unit, for example.

A subject matter of the invention is also a motor vehicle which comprises a vehicle roof of the kind described above and in which a roof module is placed in particular on a vehicle carcass, said roof module being configured as a so-called roof sensor module.

Further advantages and advantageous embodiments of the subject matter of the invention can be gathered from the description, the drawing and the patent claims.

Illustrative examples of a motor vehicle having a vehicle roof according to the invention are illustrated schematically simplified in the drawing and are described in more detail hereinafter.

### BRIEF DESCRIPTION OF DRAWINGS

FIG. 1 shows a perspective top view of a roof area of a vehicle roof with a vehicle roof according to the invention;

FIG. 2 shows a schematic side view of the roof area;

FIG. 3 shows a schematic top view of the roof area;

FIG. 4 shows sections of a schematic side view of the roof area with a sensor module aligned in the front direction;

FIG. 5 shows a view corresponding to FIG. 4, however, with the sensor module aligned upwards;

FIG. 6 also shows a view corresponding to FIG. 4, however, with the sensor module aligned in the direction of the vehicle interior;

FIG. 7 shows sections of a top view of the vehicle roof with the sensor module aligned in the direction of the front of the vehicle;

FIG. 8 shows a view corresponding to FIG. 7, however, with the sensor module aligned in the transverse vehicle direction;

FIG. 9 also shows a view corresponding to FIG. 7, however, with the sensor module aligned in the direction of the vehicle interior;

FIG. 10 shows a perspective outer view of the sensor module;

FIG. 11 shows a perspective inner view of the sensor module with an alignment in the direction of the front of the vehicle;

FIG. 12 shows a view corresponding to FIG. 11, however, with an alignment of the sensor module in the cardinal direction;

FIG. 13 also shows a view corresponding to FIG. 11, however, with an alignment of the sensor module in the transverse vehicle direction;

FIG. 14 also shows a view corresponding to FIG. 11, however, with an alignment of the sensor module in the direction of the vehicle interior;

FIG. 15 shows the sensor module without sensor covers with an alignment in the direction of the front of the vehicle;

FIG. 16 shows a view corresponding to FIG. 15, however, with an alignment in the cardinal direction;

FIG. 17 also shows a view corresponding to FIG. 15, however, with an alignment of the sensor module in the transverse vehicle direction;

FIG. 18 also shows a view corresponding to FIG. 15, however, with an alignment of the sensor module in the direction of the vehicle interior;

FIG. 19 shows a perspective view of an alternative embodiment of a sensor module with an alignment in the direction of the front of the vehicle;

FIG. 20 shows a view corresponding to FIG. 19, however, with an alignment in the transverse vehicle direction;

FIG. 21 also shows a view corresponding to FIG. 19, however, with an alignment in the direction of the vehicle interior;

FIG. 22 also shows a view corresponding to FIG. 19, however, with an alignment of the sensor module in the cardinal direction;

FIG. 23 shows a top view of the sensor module according to FIG. 19 with an alignment in the direction of the front of the vehicle;

FIG. 24 shows a view corresponding to FIG. 23 with an alignment of the sensor module in the transverse vehicle direction;

FIG. 25 also shows a view corresponding to FIG. 23, however, with the alignment of the sensor module in the direction of the vehicle interior; and

FIG. 26 also shows a view corresponding to FIG. 23, however, with an alignment of the sensor module in the cardinal direction.

### DETAILED DESCRIPTION

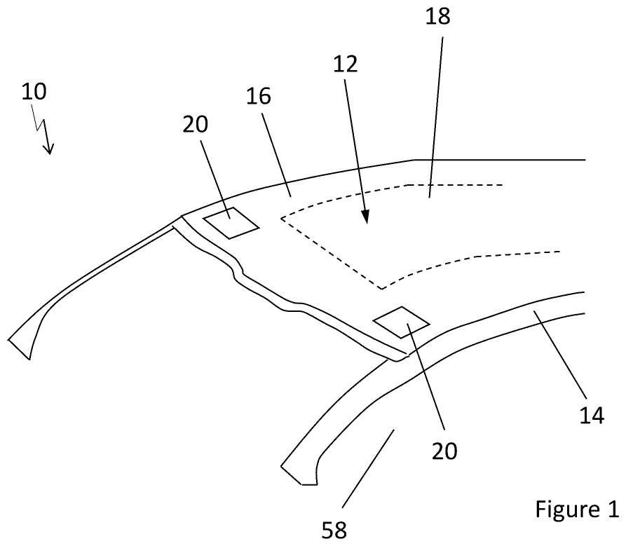

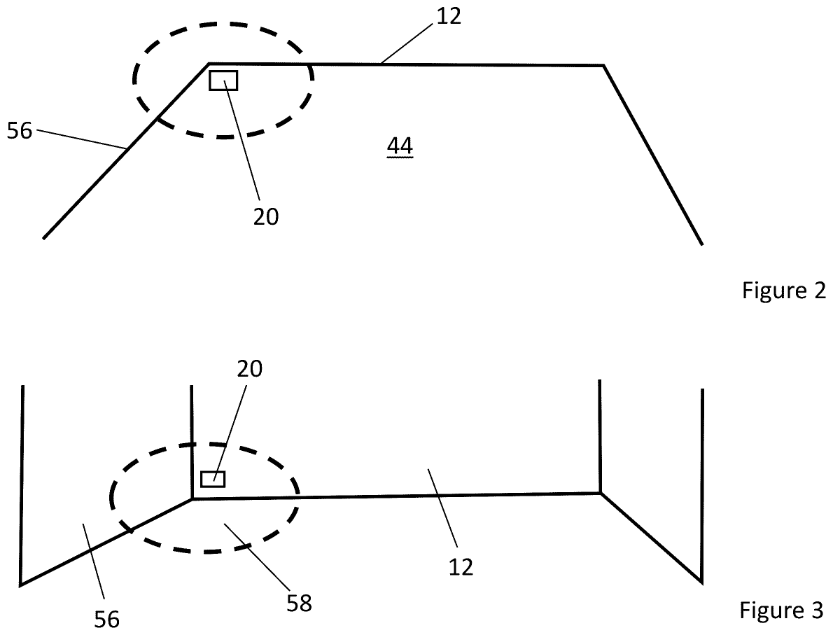

FIGS. 1 to 9 show an upper portion of a motor vehicle 10 which is configured as a passenger car and which has a vehicle roof 12 which is configured as a roof module and which is adjacent to a roof side rail 14 on either side of a vertical longitudinal center roof plane, said roof side rail 14 being part of a vehicle body representing a carcass. Vehicle roof 12 is rigidly connected to said roof side rails 14.

Vehicle roof 12 comprises a carrying element 16, which is configured as a roof frame and which forms an interface to the vehicle body, and a roof skin 18, which forms an outer viewing area and essentially stretches over the entire surface of vehicle roof 12. Roof skin 18 can be formed in one piece or be assembled from several cover elements.

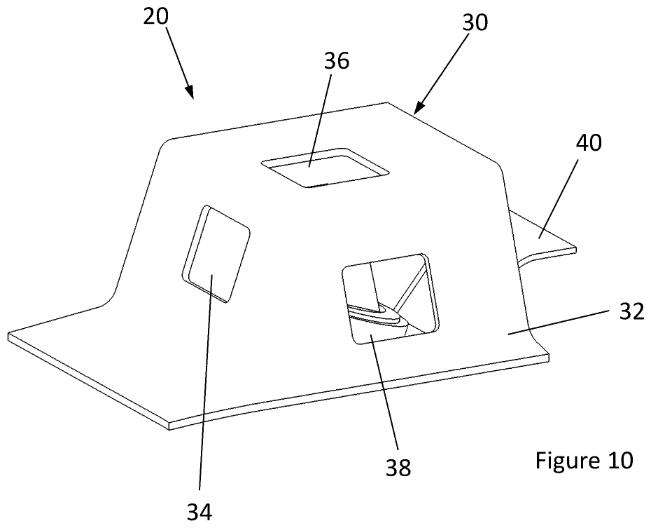

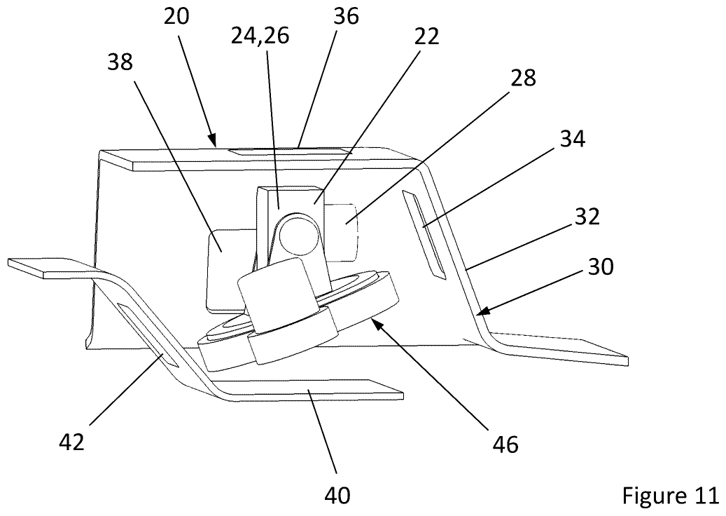

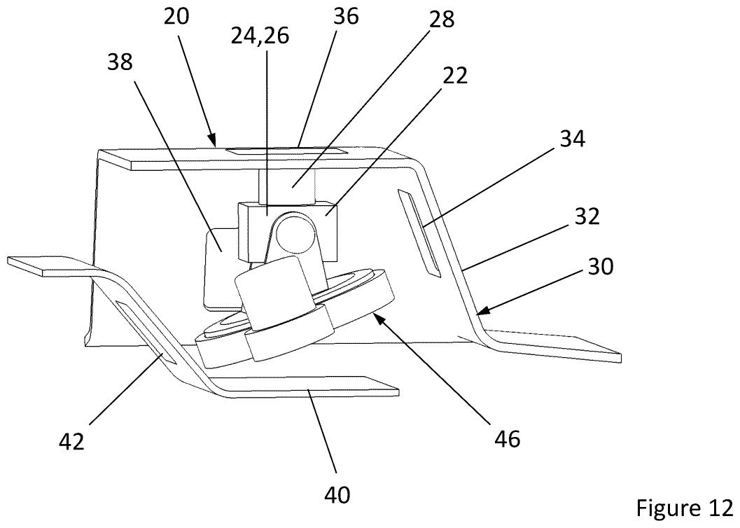

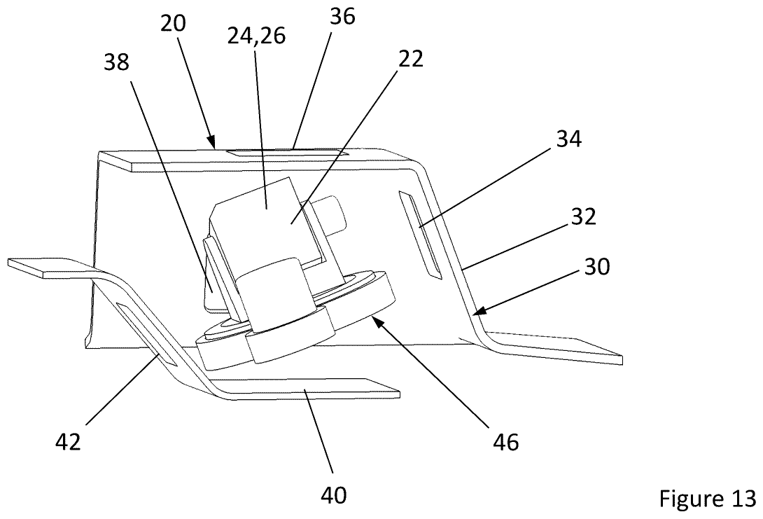

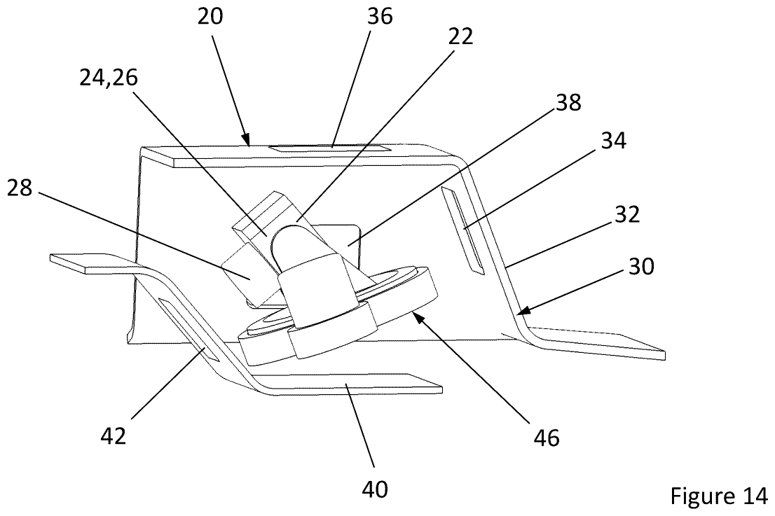

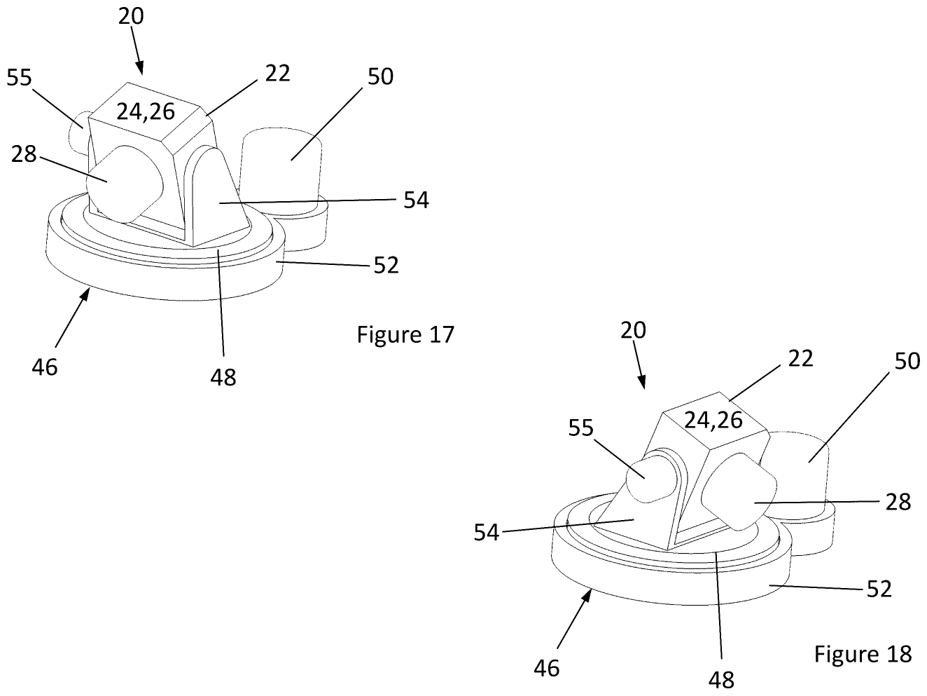

Vehicle roof 12 is configured as a roof sensor module (RSM) which has devices that allow motor vehicle 10 to be driven autonomously. To this end, vehicle roof 12 has a sensor system which comprises one sensor module 20, in particular in each front corner area, said sensor module 20 being disposed on carrying element 16 representing a roof substructure. Each sensor module 20, of which the sensor module disposed in the front left in longitudinal vehicle direction is shown in more detail in the FIGS. 10 to 18, comprises two environment sensors 24 and 26 which are accommodated in a shared housing 22 and which are different types of sensors and which can be configured in particular as optical sensors, such as a camera, as lidar sensors, as radar sensors or the like. Environment sensors 24 and 26, which both work with electromagnetic radiation, can communicate with the environment via a sensor lens 28 representing a housing opening. Measuring signals collected by environment sensors 24 and 26 can be processed by a control unit (not shown) of motor vehicle 10, so that a respective traffic situation, among other things, can be determined and motor vehicle 10 can autonomously or independently adapt to the determined traffic situation and act accordingly.

The two sensor modules 20, which are formed mirror-symmetrically to each other, each comprise one sensor cover arrangement 30, which comprises a first, housing-like cover element 32, which surrounds environment sensors 24 and 26 and which is provided with three windows 34, 36 and 38 which represent cover openings and via which environment sensors 24 and 26 can detect the environment with a correspondingly oriented sensor lens 28. In addition, sensor cover arrangement 30 comprises an angled cover plate 40, which is provided with a window 42 representing a cover opening via which environment sensors 24 and 26 can detect an interior 44 of motor vehicle 10.

Furthermore, each sensor module 20 comprises a displacement element 46 by means of which sensor lens 28 can be oriented in the direction of one of the windows 34, 36, 38 and 42 of sensor cover arrangement 30, depending on the requirements. Displacement element 46 comprises a rotary plate 48 which is mounted on a roof-mounted plate bearing and which is rotatable by means of an actuator 50, which is configured as an electric motor. Rotary plate 48 or its plate bearing and actuator 50 are fixed to carrying element 16 of vehicle roof 12. The drive of rotary plate 48 by means of actuator 50 is carried out via a spur gear stage 52.

A bracket-like bearing element 54 is disposed on rotary plate 48; housing 22 of environment sensors 24 and 26 being mounted so as to be pivotable on the free legs of said bearing element 54. Pivoting housing 22 on bearing element 54 can be carried out by means of an electric motor 55 which is mounted on bearing element 54, but can also be accommodated by housing 22 of environment sensors 24 and 26.

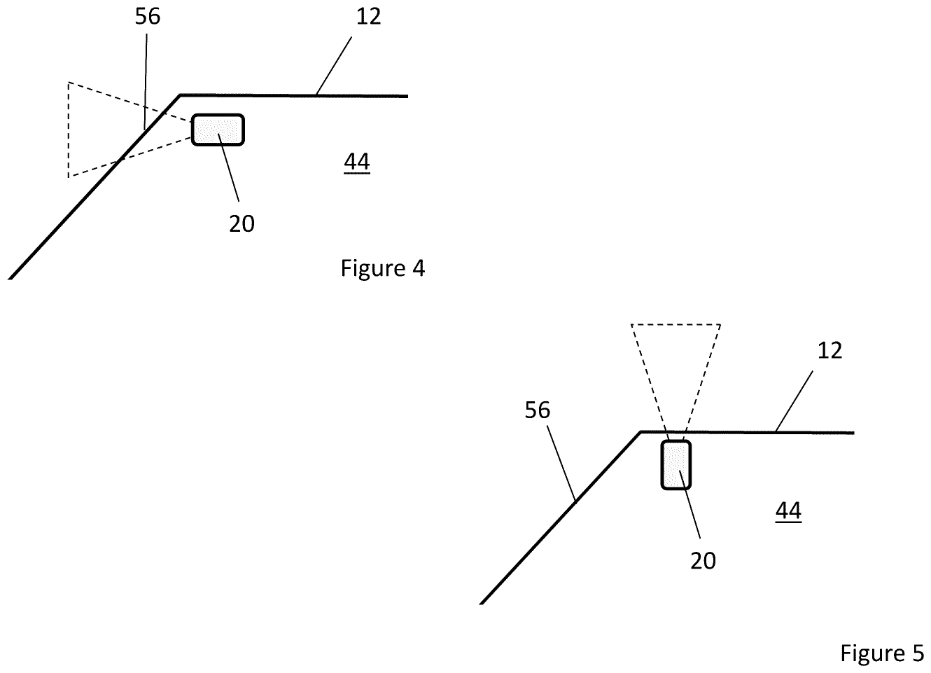

By means of displacement element 46 it is possible to align sensor lens 28 with cover window 34 according to the illustration in FIGS. 4, 7, 11 and 15. In this case, environment sensors 24 and 26 can detect the vehicle environment through window 34 of cover element 32 and through a windshield 56 of motor vehicle 10, which serves as a sensor see-through portion. Alternatively, sensor module 20 can also be disposed such that it detects the vehicle environment in front of the vehicle direction through a sensor see-through portion formed on the roof skin. The alignment of the sensor module or the sensor lens in the direction of front of the vehicle illustrates a first detection direction of sensor module 20.

The first detection direction of sensor module 20 pointing to the direction of the front of the vehicle is essentially used for the autonomous driving mode of motor vehicle 10, for example for recording and determining traffic situations or the vehicle environment, for speed control, for emitting light signals and/or the like.

By actuating displacement element 46, housing 22 of environment sensors 24 and 26 can be pivoted in the direction of upper window 36, so that environment sensors 24 and 36 can detect the vehicle environment located above motor vehicle 10 through window 36 and roof skin 18. For example, this sensor alignment serves to capture the sky above motor vehicle 10 and its reproduction on a display integrated in the inside of vehicle roof 12. Monitoring the vehicle environment above motor vehicle 10 can also be necessary in a parking manoeuvre, for example when parking in a vertical parking garage, or when transporting motor vehicle 10. The alignment of sensor lens 28 on upper window 36 of sensor cover arrangement 30 illustrates a second detection direction of sensor module 20, which is shown in FIGS. 5, 12 and 16.

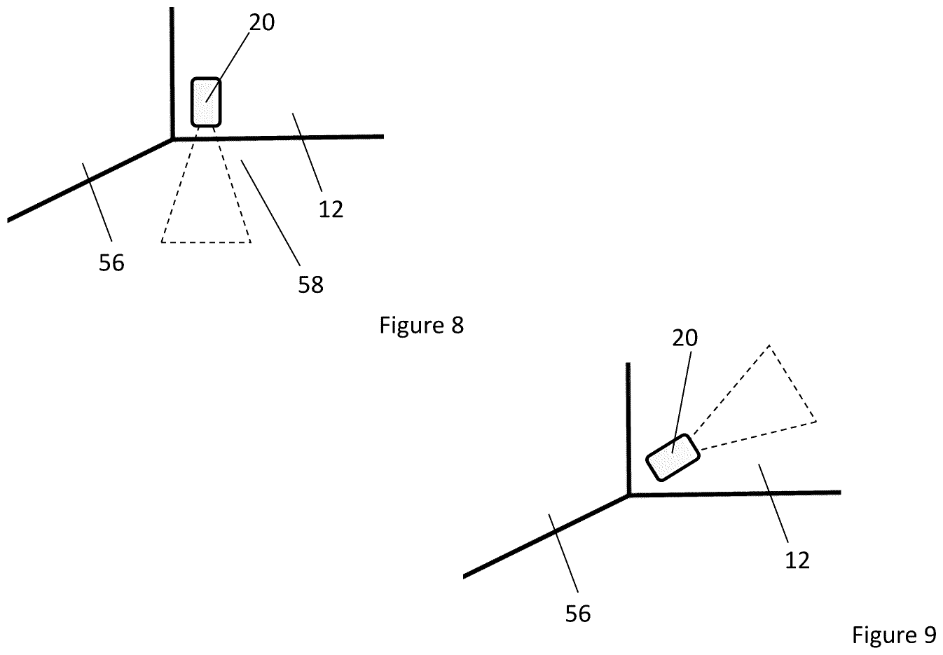

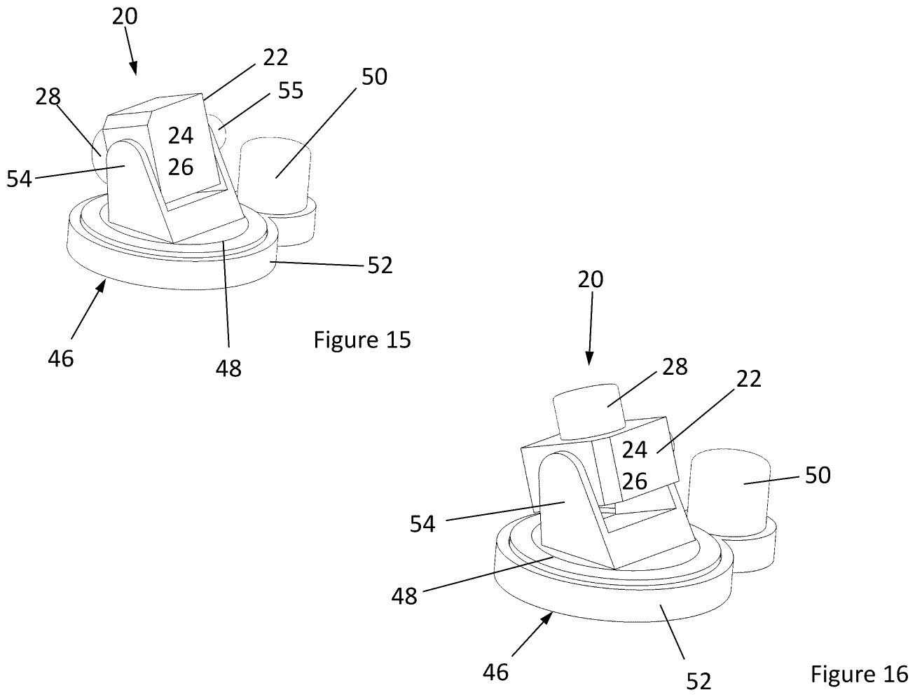

For realizing a third detection direction, which is shown in FIGS. 8, 13 and 17 and in which sensor lens 28 points to side window 38 of sensor cover arrangement 30, housing 22 of environment sensors 24 and 30 is brought to the respective pivoting position on bearing element 54 and rotary plate 48 is rotated by 90° by means of actuator 50 relative to the position shown in FIGS. 15 and 16. As a result, environment sensors 24 and 26 can detect the vehicle environment next to the motor vehicle through window 38 and a side window 58 or through a side portion of roof skin 18 representing a sensor see-through portion.

The third detection direction, in which sensor lens 28 points to side window 38, can be used, for example, for parking manoeuvres, for driving off-road, for specific driving situations in the autonomous driving mode, for a driving mode with a trailer and/or the like.

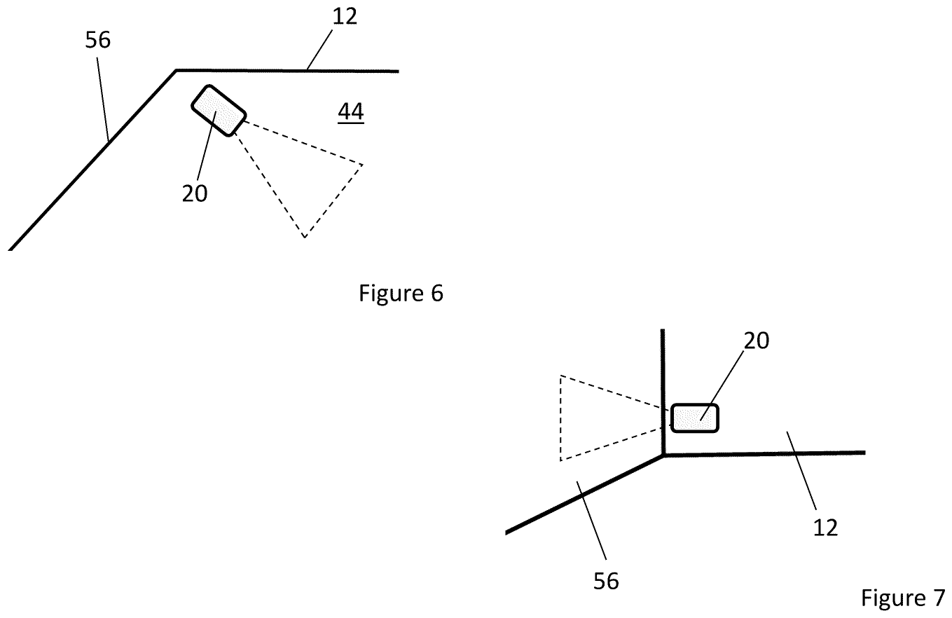

For realizing a fourth detection direction of sensor module 20, which is shown in FIGS. 6, 9, 14 and 18, rotary plate 48 is rotated by means of the actuator and housing 22 of environment sensors 24 and 26 is pivoted on bearing element 54 such that sensor lens 28 points to window 42 of cover plate 40. In this way, environment sensors 24 and 30 can detect interior 44 of motor vehicle 10 through window 42 and a possibly further sensor see-through portion formed on the inside of vehicle roof 12, for example to determine the occupancy of the vehicle interior, to detect fatigue of a vehicle occupant, to detect possibly forgotten objects in the vehicle interior, to determine the air concentration in the vehicle interior and/or to use environment sensors 24 and 30 for infotainment purposes or other purposes.

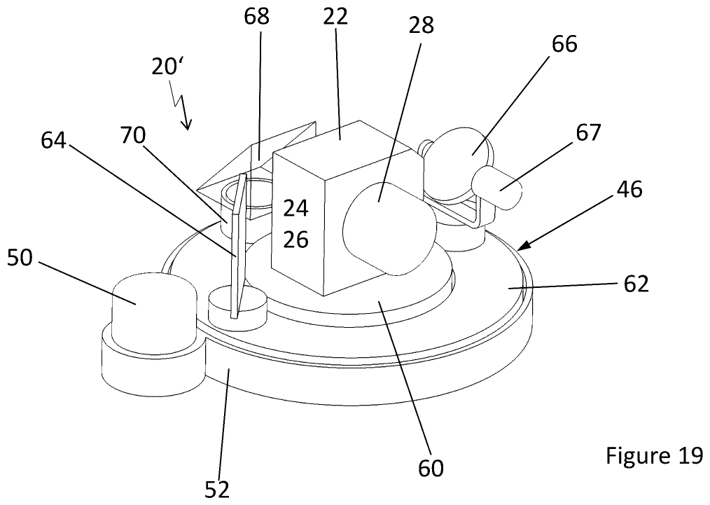

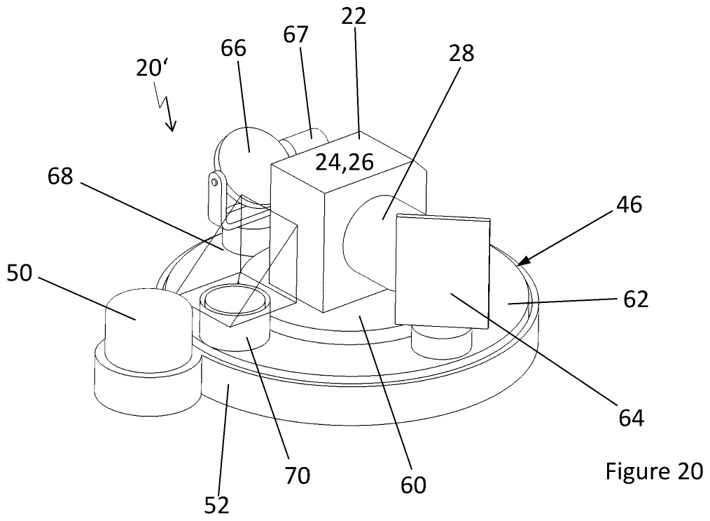

FIGS. 19 to 26 show a sensor module 20′ which is a part of a vehicle roof of the kind described above and which is also disposed in a front corner area of a roof frame below a roof skin and which, according to the embodiment described above, is provided with a displacement element 46 which allows displacing the field of observation of environment sensors 24 and 26 disposed in a housing 22 to different detection directions. Housing 22 is provided with a sensor lens 28 which represents a housing opening and through which environment sensors 24 and 26 can communicate with the environment. Housing 22 is disposed on a bearing plate 60 which is rigidly connected to carrying element 16 or the roof frame of vehicle roof 12. Therefore, environment sensors 24 and 26 and their sensor lens 28 are also rigidly disposed relative to carrying element 16 of vehicle roof 12.

Displacement element 46 of sensor module 20′ comprises a ring-like rotary plate 62 which can be driven via a spur gear stage 52 by an actuator 50 which is configured as an electric motor. A mirror 64, which is disposed so as to be immovable relative to rotary plate 62, a mirror 66, which is pivotable around a horizontal axis relative to rotary plate 62, and an optical prism 68 are disposed on ring-like rotary plate 62, said optical prism 68 being disposed on a tube piece 70, which corresponds with a hole 72 formed in ring-like rotary plate 62.

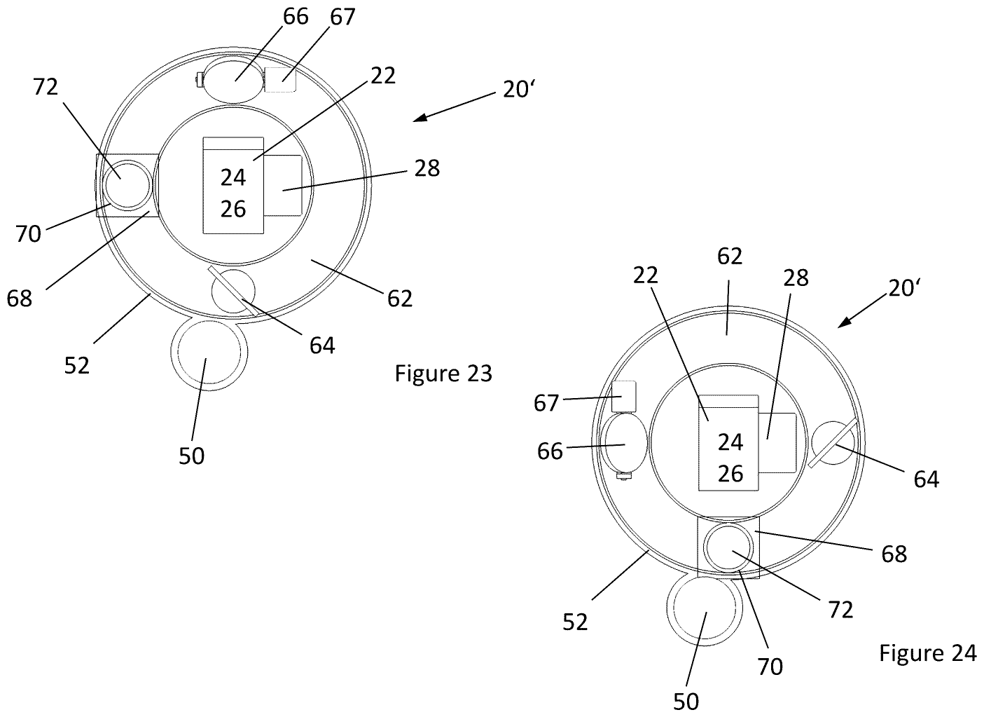

In a first detection direction of sensor module 20′ shown in FIGS. 19 and 23, rotary plate 62 assumes a rotating position in which sensor lens 28, which points to the direction of front of the vehicle, can freely view the vehicle environment in front of the motor vehicle and detect it for an autonomous driving mode of the vehicle.

For realizing a second detection direction in which a surrounding area next to the respective is to be detected, rotary plate 62 is rotated by means of actuator 50 such that fixed mirror 64 is in front of sensor lens 28 and environment sensors 24 and 26 can detect the side vehicle environment mirrored on mirror 64.

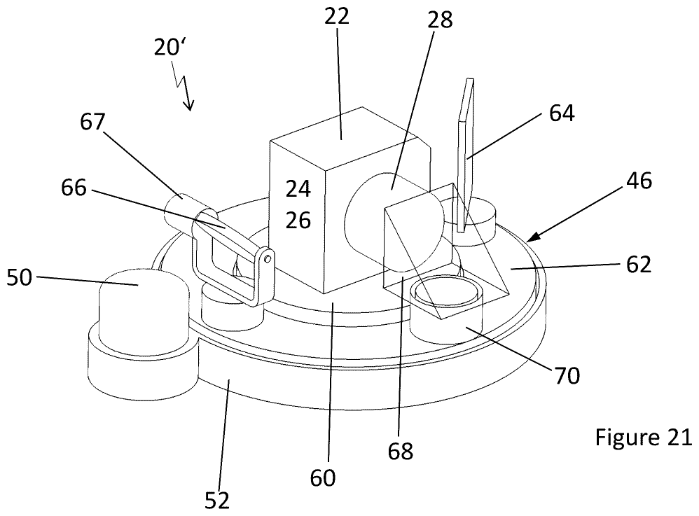

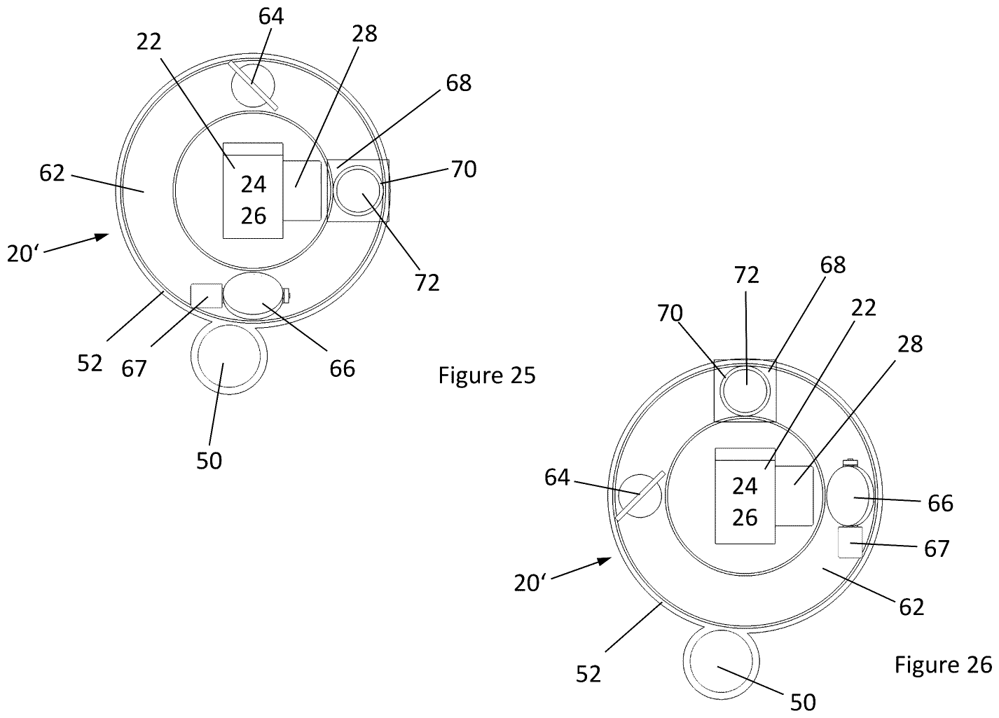

For realizing a third detection direction of sensor module 20′, which is illustrated in FIGS. 21 and 25, rotary plate 62 is rotated such by means of actuator 50 that optical prism 68 is disposed in front of sensor lens 28. Thus, environment sensors 24 and 26 can detect the interior of the respective motor vehicle located below vehicle roof 12 via optical prism 68, tube piece 70 and hole 72, for example for determining an interior occupancy or the like.

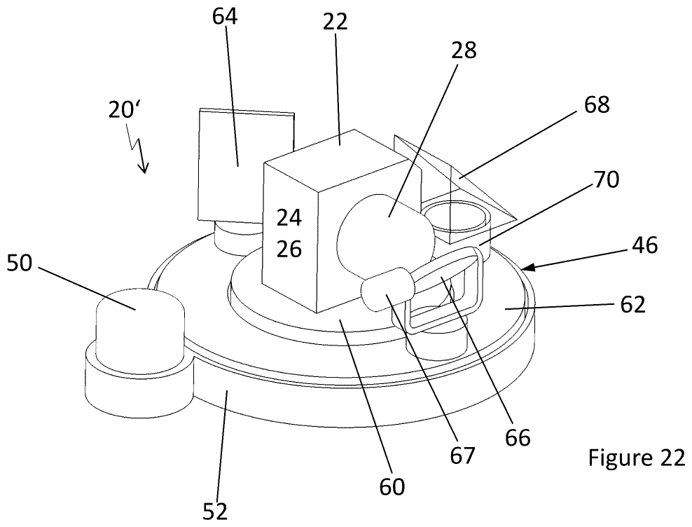

For a fourth detection direction of sensor module 20′, rotary plate 62 is rotated such that pivotable mirror 66 is positioned in front of sensor lens 28 (cf. FIGS. 22 and 26). As a result, environment sensors 24 and 26 can detect the vehicle environment above motor vehicle 10 mirrored on mirror 66. For example, a sky image can be recorded in this manner by means of a camera, which is realized by one of environment sensors 24 and 26. The pivoting position of mirror 66 can be adjusted using an electric drive 67.

### LIST OF REFERENCE SIGNS

10 motor vehicle
12 vehicle roof
14 roof side rail
16 carrying element
18 roof skin
20, 20′ sensor module
22 housing
24 environment sensor
26 environment sensor
28 sensor lens
30 sensor cover arrangement
32 cover element
34 window
36 window
38 window
40 cover plate
42 window
44 interior
46 displacement element
48 rotary plate
50 actuator
52 spur gear stage
54 bearing element
55 electric motor
56 windshield
58 side window
60 bearing plate
62 rotary plate
64 mirror
66 mirror
67 electric drive
68 optical prism
70 tube piece
72 hole

1. A vehicle roof, comprising:
a roof skin,
a carrying element, and
at least one sensor module having an environment sensor arrangement which is disposed on the carrying element and by means of which a vehicle environment is detectable for an autonomous and/or semi-autonomous driving mode of the respective vehicle,
wherein the sensor module is provided with a displacement element by means of which it is displaceable between at least two detection directions.

2. The vehicle roof according to claim 1, wherein the detection directions into which the sensor module is displaceable comprise a detection direction towards a front of the vehicle and/or a detection direction towards a side of the vehicle and/or a detection direction towards a back of the vehicle and/or a detection direction upwards and/or a detection direction towards a vehicle interior.

3. The vehicle roof according to claim 1, wherein the displacement element comprises a rotary plate.

4. The vehicle roof according to claim 1, wherein the displacement element comprises a bearing element on which the environment sensor arrangement is mounted so as to be pivotable.

5. The vehicle roof according to claim 4, wherein the displacement element comprises a rotary plate, and wherein the bearing element is disposed on the rotary plate.

6. The vehicle roof according to claim 1, wherein the sensor module comprises at least one beam deflecting element by means of which the electromagnetic radiation, which the environment sensor arrangement uses, is deflectable.

7. The vehicle roof according to claim 6, wherein the beam deflecting element comprises a pivotable mirror and/or a fixed mirror and/or an optical prism.

8. The vehicle roof according to claim 6,
wherein the displacement element comprises a rotary plate, and
wherein the beam deflecting element is disposed on the rotary plate.

9. The vehicle roof according to claim 1, wherein the sensor module is provided with at least one sensor cover which has cover openings, which are each assigned to one detection direction.

10. The vehicle roof according to claim 1, wherein the environment sensor arrangement comprises at least two different types of sensors, which are usable simultaneously or independently, and comprises an optical sensor, such as a camera, a lidar sensor, a radar sensor and/or a sonar.

11. The vehicle roof according to claim 1, wherein it is a roof module which forms a modular unit which is connectable to a vehicle body.

12. A motor vehicle comprising a vehicle roof according to one of the features of claim 1.
